(19) United States
(12) Patent Application Publication
(10) Pub. No.: US 2007/0009879 A1
(43) Pub. Date: Jan. 11, 2007

(54) Potty training method using toilet paper with cartoon characters

(76) Inventor: Leigh Kentof, Franklin, TN (US)

Correspondence Address: WADDEY & PATTERSON, P.C., 1600 DIVISION STREET, SUITE 500, NASHVILLE, TN, 37203, US

(21) Appl. No.: 11/169,185

(22) Filed: Jun. 28, 2005

(51) Int. Cl. G09B 25/00

(52) U.S. Cl. 434/365

(57) ABSTRACT

Disclosed herein is a method of potty training children by employing toilet paper that has cartoon characters imprinted upon the toilet paper. The toilet paper is imprinted with images of well known, highly visible, and widely recognized cartoon characters. These characters have already been promoted and marketed to the children over their early years through books, magazines, television and movies. Thus, the child has created affection for the cartoon characters and wants to have access to them. As soon as the child senses the urge to go to the bathroom, he or she will communicate that to the parent so that the child gets to see, and ultimately use, his or her toilet paper. Of course, as part of the process, the toilet paper must be generally kept in reserve and out of reach for the child, and only be made available to the child after a successful potty experience. Also, disclosed is a toilet paper storage device which can be mounted on the wall adjacent to the toilet so that the child can see the toilet paper with his or her favorite cartoon characters on it, but cannot have access to the paper accept upon a successful potty training experience.

### CROSS-REFERENCES TO RELATED APPLICATIONS

There are no related pending patent applications with respect to the present invention.

### BACKGROUND OF THE INVENTION

The present invention relates generally to a method of potty training children. Parenting has a multitude of rewards, but it also carries its fair share of burdens. One of those burdens is the obligation to potty train the child. While the need for potty training is almost as old as mankind itself, there has been very little evolution in the technique of potty training. In fact, while psychologist might choose to differ, it can be fairly said that there are no “modern” techniques of potty training children. The methodology of potty training children does not appear to have changed for hundreds of years.

The known techniques of potty training children generally revolve around a substantial amount of coaxing, attempts by the parent to be observant of their children's characteristics and habits, and attempting to spot those moments when the child seems to have a need to go to the bathroom, setting the child on a toilet, and allowing the child to sit there until bowel movement or urination and then rewarding the child with high praise. Most all techniques involved in potty training revolve around the concept of rewarding the child for going to the bathroom after the act takes place. These techniques generally involve the concept of “pushing” the child toward the concept of potty training, or rewarding the child after a successful potty experience. However, there are few if any methods, systems, or products on the market which are designed to cause the child to want to go to the bathroom. One such product is a “musical potty” sold under the brand name “Tinkle Toonz” and can be viewed at www.tinkletoonz.com.

The deficiencies of most prior art techniques are that they attempt to push a child toward accepting potty training rather than creating an atmosphere to attract the child to the potty training process. Applicant's method overcomes this deficiency of the prior art.

### BRIEF SUMMARY OF THE INVENTION

Applicant's invention relies somewhat on the old adage “that it is easier to pull a rope than to push it.” Specifically, applicant has developed a new and unique method of potty training children by employing toilet paper that has cartoon characters imprinted upon the toilet paper.

By imprinting toilet paper with the child's favorite cartoon characters that have been the subject of books, television shows, commercials and movies, the child is “pulled” toward the potty training process by the desire to have access to the toilet paper having his or her favorite cartoon characters imprinted on it. Under the method of potty training children of the present invention, the toilet paper is imprinted with images of well known, highly visible, and widely recognized cartoon characters. These characters have already been promoted and marketed to the children over their early years through books, magazines, television and movies. Thus, the child has created affection for the cartoon characters and wants to have access to them. The cartoon character “Barney®” is a prime example. Children see Barney® cartoons, read Barney® books, have Barney® dolls, and may even go to Barney® movies. Thus, Barney® becomes the child's friend. As such, the child wants access to the cartoon character and if the cartoon character is imprinted on toilet paper, and the only access to that toilet paper is when the child has a successful potty training experience, the child's awareness of the need to use the potty is enhanced.

As soon as the child senses the urge to go to the bathroom, he or she will communicate that to the parent so that the child gets to see, and ultimately use, his or her toilet paper. Of course, as part of the process, the toilet paper must be generally kept in reserve and out of reach for the child, and only be made available to the child after a successful potty experience. As additional encouragement to the child to be aware of the urge to go to the bathroom, the toilet paper of the present invention may be treated with a litmus material that will make it change color when it contacts the water in the toilet, and the treatment can be in the form of an expression, such as the words WOW, GOOD BOY, GREAT, or the like.

Also, disclosed is a toilet paper storage device which can be mounted on the wall adjacent to the toilet so that the child can see the toilet paper with his or her favorite cartoon characters on it, but cannot have access to the paper accept upon a successful potty training experience.

### DRAWINGS

FIG. 1 shows a potty training setting in a bathroom with a toilet and wall mounted toilet paper dispensing case consistent with the present invention.

FIG. 2 is a toilet paper dispensing case in prospective view.

FIG. 3 is a side view and cross section of the toilet paper dispensing case of FIG. 2.

FIG. 4 is a frontal view and cross section of the toilet paper dispensing case of FIG. 2.

FIG. 5 is a front view of the toilet paper dispensing case of FIG. 2 with the door open and the toilet paper exposed for the child's use.

FIG. 6 shows the toilet paper that has been treated with a litmus material in a pattern that will show words of encouragement when the toilet paper comes in contact with the water in the toilet.

### DETAILED DESCRIPTION OF THE PREFERRED EMBODIMENT

The invention will be best understood when consideration is given to the following detailed description of the preferred embodiment of the invention, discussed in conjunction with the attached drawings wherein like reference numerals refer to like parts.

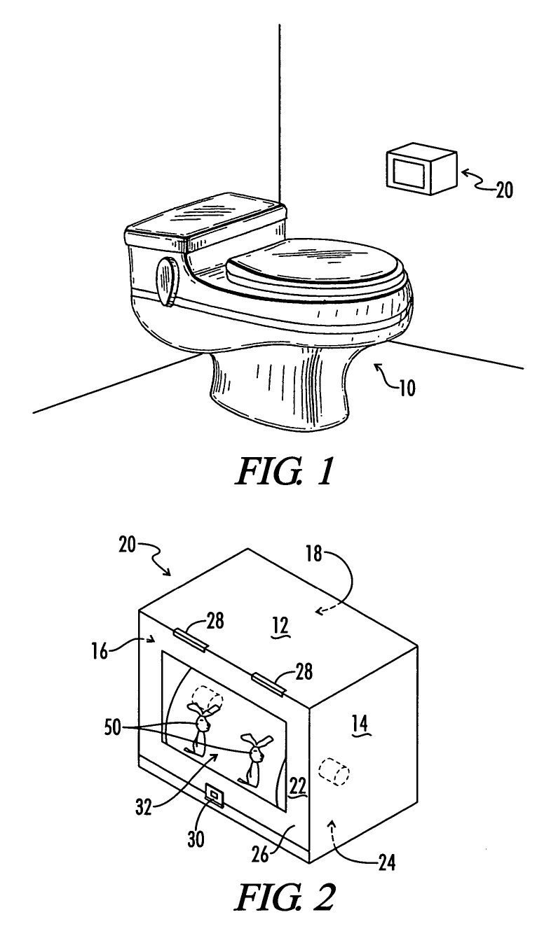

Referring first to FIG. 1, the normal potty setting is generally illustrated. Potty training can take place either in a bathroom, or in a special potty chair which is a miniature toilet that can be moved from one location to another in the child's home. However, in preferred potty training practice, the training should take place in the bathroom, whether with the full size toilet (10) having a child seat over the toilet bowl, or with a separate smaller child's toilet of known construction. Attached to the wall adjacent to the toilet (10) is a toilet paper storage and dispensing case (20) that is illustrative of the present invention. The case (20) is shown in prospective view in FIG. 2 at a larger scale that can be more readily understood.

The case (20) is generally a box that can be mounted to the wall. The case (20) includes a top (12), a right side (14), a left side (16), a back (18), a front (22), and a bottom (24). The back is optional because a case without a back can be mounted over the traditional toilet paper rack. The case (20) is designed to be mounted to the wall by any convenient means such as screws or clips (not shown).

The front (22) of the case (20) includes a hinged panel (26) connected to the top (12) by hinges (28). The panel (26) can be secured in a closed position by a lock (30) which is opened by a key (not shown) retained by the parent.

The panel (26) includes a window section (32) that can be either glass, plastic or some other clear or transparent material so as to expose the contents of the inside of the case (20). The remainder of the case is either wood or some other opaque material such as plastic or the like so that the interior contents of the case (20) are generally viewable only through the window (32).

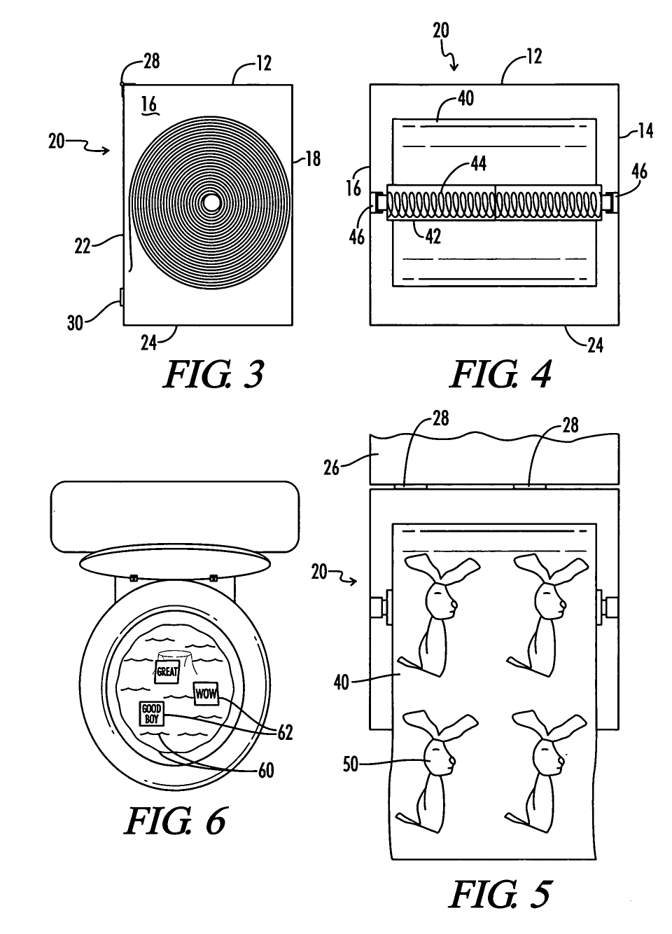

Looking at FIG. 3, the case (20) is shown in cross section with the toilet paper that is used to implement the process of the present invention mounted inside the case (20). FIG. 4 is a front cut away view of the case (20) showing the toilet paper (40) used to implement the present invention. The toilet paper (40) is mounted on a spindle (42) of known construction which may be spring loaded by spring (44) with the spindle passing through the core of the toilet paper roll and ends of the spindle fitting into pockets (46) in the sides (14) and (16) respectively of the case (20).

Looking next at FIG. 5, the panel (26) is shown lifted along hinge line (28) with the toilet paper (40) used to implement the present invention rolled out of the case (20). The toilet paper (40) shows cartoon characters (50) embossed on the toilet paper. Cartoon characters (50) can also be seen through the window (32) of the case when the panel 22 is closed and locked (see FIG. 1).

Referring to FIG. 6, the embodiment of the toilet paper that has been impregnated with a litmus coating is illustrated. Litmus is a well known organic compound made from lichens and is safe and a non-irritant. The paper is preferably impregnated with litmus in a pattern that will be novel to the child and will cause him or her to want to see the pattern become visible when the paper comes into contact with the water 60 in the toilet. The pattern can be in the form of characters or words 62. Words 62 such as WOW, GOOD BOY, GREAT, and the like are preferred. Also, the litmus causes the words to appear in bright colors, depending on the ph balance of the urine in the toilet bowl. The color will be red-orange if the urine is acidic or green-blue if alkaline. The preferred litmus solution is 0.5% litmus, 99.5% water.

When the child is ready for potty training, he or she will be told that his favorite cartoon characters are locked in the case (20) and can only be released upon a successful potty training experience. When the child goes to the potty, the parent uses the key to open the lock (30) and lift the panel (26) and allow the toilet paper to be rolled out of the case and handed to the child for the normal use of the toilet paper. Thus, the child gets to rescue his or her favorite cartoon characters and is therefore encouraged by the process to go to the bathroom and will alert the parent to his or her needs for a potty training experience.

If the child has the traditional “accident” and fails to make it to the potty on time, the cartoon characters remain locked in the case and are not released until the next successful potty training experience, with ordinary toilet paper used instead of the cartoon character toilet paper.

Having described generally my invention, the scope of the invention is limited only by the claims as set forth herein.

What is claimed is:

1. A potty training method for children including the steps of:
a. encouraging a child to use a toilet when a child has the urge to urinate or defecate by:
(1) providing toilet paper with cartoon characters shown on the toilet paper;
(2) keeping said toilet paper from the child in the normal course;
(3) allowing the child to use said toilet paper upon a successful potty training experience; and,
b. denying the child access to said toilet paper except upon the completion of a successful potty training experience.

2. A method of potty training a child including the steps of:
a. visually presenting to the child a roll of toilet paper with cartoon characters printed thereon;
b. denying the child the opportunity to touch said toilet paper except upon the completion of a successful potty training experience; and,
c. rewarding the child upon a successful potty training experience by allowing the child to use the said toilet paper.

3. A method of potty training a child including the steps of:
a. showing the child toilet paper having cartoon characters illustrated thereon;
b. placing said toilet paper in a enclosed case;
c. instructing the child that he or she can release the cartoon characters only upon a successful potty training experience; and
d. rewarding the child upon a successful potty training experience by allowing the child to use said toilet paper.

4. A potty training tool, said tool including, in combination:
a. a case for holding toilet paper and designed to be mounted on a wall;
b. said case including a top, bottom, opposing sides, and a front;
c. said front including a hinged panel and lock that allows the panel to be secured in place so that contents inside the case cannot be accessed, and when the case is unlocked and the panel is opened, the contents inside the case can be accessed; and,
d. a toilet paper spindle inside said case.

5. The tool of claim 4 further including a window in said panel.

6. The tool of claim 4 further including toilet paper inside the case, said toilet paper including cartoon characters illustrated thereon.

7. A method of potty training a child using toilet paper with cartoon characters illustrated thereon; said method including the step of allowing the child to use said toilet paper only upon the completion of a successful potty training experience.

8. Toilet paper impregnated with a chemical reagent, said reagent applied in a pattern and being invisible until and unless the toilet paper comes in contact with a liquid, said reagent causing the pattern to materialize visually when the toilet paper comes in contact with a liquid.

9. The toilet paper of claim 8 where said reagent is non-toxic and non-irritant.

10. The toilet paper of claim 8 where said reagent is litmus.

11. The toilet paper of claim 8 where said pattern is at least one laudatory word.

12. The toilet paper of claim 8 where said liquid is water and urine.
